(19) United States
(12) Patent Application Publication
(10) Pub. No.: US 2024/0412116 A1
(43) Pub. Date: Dec. 12, 2024

(54) SYSTEM AND METHOD FOR COMMUNICATING A DISTRIBUTED LEARNING AND ACTIVATION MODEL FOR A MACHINE LEARNING PROGRAM

(71) Applicant: LIT8 SAS, Paris (FR)

(72) Inventors: William Chun Sing Anger, Ivry-sur-Seine (FR); Shmuel Silverman, Novato, CA (US)

(21) Appl. No.: 18/736,197

(22) Filed: Jun. 6, 2024

Related U.S. Application Data
(60) Provisional application No. 63/506,740, filed on Jun. 7, 2023.

(51) Int. Cl. G06N 20/20

(52) U.S. Cl. CPC G06N 20/20

(57) ABSTRACT

The present disclosure describes a system and method for communicating distributed learning and activation model for machine learning program in any environment. The system includes a plurality of computing nodes in communication with each other through a network. The computing nodes include a set of first computing nodes and a set of second computing nodes. The first computing node is configured to manage one set of machine learning models and the second computing node is configured to manage another set of machine learning models. The first computing node and second computing node are configured to provide timely information to update the model dynamically being learned. The first computing node and second computing node variably update the model. The updates are independent of network delays.

### CROSS-REFERENCE TO RELATED APPLICATION

This application claims the priority benefit of U.S. Provisional Patent Application No. 63/506,740 entitled “System and Method for Communicating a Distributed Learning and Activation Model for a Machine Learning Program,” filed Jun. 7, 2023, the contents of which is herein incorporated by reference in its entirety.

### TECHNICAL FIELD

The present disclosure generally relates to machine learning and, more particularly, to a system and method for communicating a distributed learning and activation model for machine learning programs in any environment.

### BACKGROUND

Simulating a computer-generated environment often involves resource-heavy activities such as rendering and re-rendering content. Several techniques are known to render simulations. One conventional technique enables a server to stream information to a client device to render content. This, in turn, allows the client device to reduce the rendering efforts to reduce impact on the local processor and may enable use of information received from the server to present rendered views to users, which may decrease the overall load on the client device. This technique works well when the server is rendering once and sending information to multiple clients all at once, thus allowing for a high reuse ratio between server efforts and clients being served.

### SUMMARY

There is a clear need for a system and method for creating content in an environment while reducing computational efforts on the server device and the client device that additionally avoids bandwidth variability between the server and the client devices. The systems and methods described herein provide a compression method that allows a server device and a client device to participate in a content simulation without degrading the user experience.

The present disclosure relates to a system for facilitating a distributed learning and activation model for a machine learning program in an environment, the system including: a plurality of computing nodes in networked communication, the plurality of computing nodes including a first set of computing nodes and a second set of computing nodes, wherein the first set of computing nodes manages a first set of machine learning models and the second set of computing node manages a second set of machine learning models, and wherein a first computing node in the first set of computing nodes and a second computing node in the second set of computing nodes cause mutual learning between two or more of the plurality of nodes by exchanging information in near real time to update the first set of machine learning models and the second set of machine learning models.

In some aspects, the techniques described herein relate to a system, wherein the first set of machine learning models is a superset of the second set of machine learning models, and wherein the first set of machine learning models is configured to be executed by at least a portion of the second set of machine learning models.

In some aspects, the techniques described herein relate to a system, wherein updating the first set of machine learning models and the second set of machine learning models occurs independent of delays and packet drops associated with a network used to exchange the information.

In some aspects, the techniques described herein relate to a system, wherein the first computing node and the second computing node are configured to variably update the distributed learning and activation model.

In some aspects, the techniques described herein relate to a system, further including: one or more databases for storing information corresponding to the environment; and object data associated with a plurality of objects, wherein the environment is a simulation environment.

In some aspects, the techniques described herein relate to a system, wherein the first computing node is configured to determine a sequence of first frames of at least one object, in the plurality of objects, to be rendered at the environment, and wherein the second computing node is configured to determine a sequence of second frames for the at least one object, in the plurality of objects, to be rendered at the environment.

In some aspects, the techniques described herein relate to a system, wherein at least one of the first computing node and the second computing node is configured to: receive at least one of the first frames and the second frames; correlate and map the first frames with the second frames to render the at least one object at the environment, wherein the machine learning model is configured to determine the at least one object to be rendered at the environment and wherein the environment is a simulation environment.

In some aspects, the techniques described herein relate to a system, wherein the sequence of first frames are mainframes and the sequence of second frames are intraframes of the at least one object to be rendered at the environment. In some aspects, the techniques described herein relate to a system, wherein the sequence of first frames are intraframes and the sequence of second frames are mainframes of the at least one object to be rendered at the environment.

In some aspects, the techniques described herein relate to a system, wherein the first computing node is a server and the second computing node is a client device, wherein the server is configured to send the mainframes to the client device and the client device is configured to be triggered to determine the intraframes and render the at least one object at the environment in response to receiving the mainframes from the server.

In some aspects, the techniques described herein relate to a system, wherein the client device is configured to send reverse mainframes to the server and reverse intraframes to the server to update the reverse mainframes, wherein the client device is configured to be triggered to send, to the server, reverse mainframes and reverse intraframes on a variable frequency and dynamic scale based on the environment and simulation at the environment.

In some aspects, the techniques described herein relate to a system, wherein the mainframes and intraframes are mapped with the reverse mainframes and reverse intraframes to render the at least one object in the environment.

In some aspects, the techniques described herein relate to a system, wherein each of the plurality of computing nodes is configured to update weights of instances associated with the first set of machine learning models and instances associated with the second set of machine learning models.

In some aspects, the techniques described herein relate to a system, wherein the first computing node and the second computing node are configured to negotiate which of the plurality of objects to select for rendering at the environment.

In some aspects, the techniques described herein relate to a method for facilitating a distributed learning and activation model for a machine learning program in an environment, the method including: providing a plurality of computing nodes in networked communication, the plurality of computing nodes including a first set of computing nodes and a second set of computing nodes; managing a first set of machine learning models by a first computing node in the first set of computing nodes and managing a second set of machine learning models by a second computing node in the second set of computing nodes; enabling a mutual learning process between the first computing node and the second computing node by: providing, by the first computing node and in near real time, a first set of information to dynamically update the first set of machine learning models, and providing, by the second computing node and in near real time, a second set of information to dynamically update the second set of machine learning models; wherein the mutual learning process is performed using compression when providing the first set of information and providing the second set of information, wherein the compression is a reversible compression between the first computing node and the second computing node and configured to reduce computational effort on the first computing node while reducing bandwidth usage when communicating between the first computing node and the second computing node.

In some aspects, the techniques described herein relate to a method, wherein the first set of machine learning models is a superset of the second set of machine learning models, and wherein the first set of machine learning models is configured to be executed by at least a portion of the second set of machine learning models.

In some aspects, the techniques described herein relate to a method, wherein the first computing node and the second computing node variably update the first set of machine learning models or the second set of machine learning models, and the updates to the first set of machine learning models and the second set of machine learning models occur independent of delays and packet drops associated with a network used to exchange the first set of information and the second set of information.

In some aspects, the techniques described herein relate to a method, wherein the first computing node is a server and the second computing node is a client device, the server being configured to send a plurality of mainframes to the client device and the client device is configured to determine a plurality of intraframes associated with the plurality of mainframes and render objects at the environment based on the plurality of mainframes and the plurality of intraframes.

In some aspects, the techniques described herein relate to a method, further including: sending, by the second computing node and to the first computing node, a plurality of reverse mainframes and a plurality of reverse intraframes to update the plurality of reverse mainframes at a variable frequency and dynamic scale based on the environment and simulations operating in the environment.

In some aspects, the techniques described herein relate to a method, wherein using the compression further includes: mapping the plurality of mainframes and the plurality of intraframes with the plurality of reverse mainframes and the plurality of reverse intraframes to render objects in the environment.

### BRIEF DESCRIPTION OF THE DRAWINGS

FIG. 1 exemplarily illustrates an example of communication between electronic devices according to some embodiments of the disclosure.

FIG. 2 is an example video compression frame sequence generated by a conventional compression algorithm.

FIG. 3 exemplarily illustrates a system for generating content in a simulation environment.

FIG. 4 exemplarily illustrates a shard forming a portion of the simulation environment.

FIG. 5 exemplarily illustrates a number of shards forming the portion of the simulation environment.

FIG. 6 exemplarily illustrates a model of a frame sequence sent from a server to a client device.

FIG. 7 exemplarily illustrates a model of a frame sequence sent from the server to the client device when a client device moves to a different shard.

FIG. 8 exemplarily illustrates a model of a set of frame sequences sent from the server to the client device.

FIG. 9 exemplarily illustrates a model of a set of frame sequences sent from the server to the client device.

FIG. 10 exemplarily illustrates a model comprising a frame sequence of R/Ri-Frame mapped to M/i-Frame to render objects in the simulation environment.

FIG. 11A is a block diagram of an example ML model based on Neuro Evolution of Augmented Topologies.

FIG. 11B is a block diagram of an example machine learning model for use with the simulation environments described herein.

FIG. 12 is a flow diagram of an example process for facilitating a distributed learning and activation model for a machine learning program in an environment for use with the simulation environments described herein.

FIG. 13 is a flow diagram of an example process for facilitating a distributed learning and activation model for a machine learning program in an environment.

FIG. 14 is an example system for learning and evolving content to be simulated and shared amongst client devices such as one or more user(s).

FIG. 15A is an example set of images that may be used to train the ML model.

FIG. 15B is an example of image data from one or more training sessions on the server device combined with sparse data.

FIG. 15C depicts an example of a fully rendered result of using sparse data and generating a fully rendered version of content within the image data.

The illustrated embodiments are merely examples and are not intended to limit the disclosure. The schematics are drawn to illustrate features and concepts and ae not necessarily drawn to scale.

### DETAILED DESCRIPTION OF EXAMPLE EMBODIMENTS

Example embodiments of the disclosure now will be described more fully hereafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

Described herein are systems and methods for facilitating a distributed learning and activation model to enable mutual learning between two or more nodes by parallelizing computational tasks performed by the nodes described herein and sharing data, training, and/or updates between nodes. The technical problem sought to be solved by the present disclosure is to provide near real time mutual learning (e.g., sharing, training, and/or content updates) between one or more nodes of a simulation environment. The technical solution provided by the embodiments described herein may include using one or more machine learning (ML) models that selectively determine which data to exchange between nodes according to user decisions within a simulated environment and which portions of the ML models associated with the nodes is to be updated to avoid network bandwidth throttling and/or device bandwidth throttling. For example, an ML model operating on a client device may determine a subset of data in which to share amongst other client device(s) (e.g., peers) to avoid having to upload and/or download content associated with a server and/or network in communication with the server. In some embodiments, the ML model operating on a client device may determine a subset of data in which to share amongst other client device(s) to avoid excessive device bandwidth usage.

Determining how the simulated environment may be changed according to user decisions within the environment and doing so in a near real time fashion may include disassociating the client devices and the server device until the ML models determined to share information can reduce communications (and thus bandwidth usage) in the environment and allow the client device to continue operations, etc., until a next frame and/or change is received from the server. In some embodiments, the disassociation between a client device and the server allows the network interface to operate at a low speed relative to a frame rate associated with a client device. For example, when the client can continuously display changes in the environment without those changes being reported to a server, the changes are being handled with the support of the ML model executing on the client device. The accumulated changes may be reflected in the updates that the client can later (or simultaneously) provide to the server. The changes may represent a sparse set of data that may enable visual, audial, and/or environmental changes for a client device without having to share the entire set of data. Such a communication may represent sparsed communication (e.g., compression of information and/or other metric of sparsely selecting portions of data) where the ML model generates any missing data using the portion of data received in the sparse communication. For example, the missing data may be generated by the client device once a communication packet is received. The local client device can continuously experience changes and handle such changes using the local ML model. For example, when one server provides data to two client devices playing a simulation game involving user participation (e.g., input), the ML model executing on one or both client devices can update visual, audial, or other data on a first client device and trigger an update of the same content on the second client device based on the update that occurred on the first client device without having to access or request an update of such content from the server.

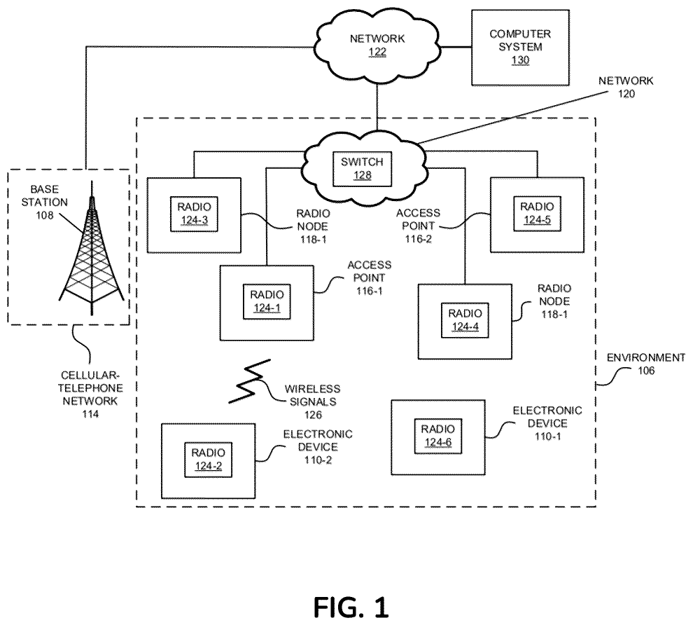

FIG. 1 presents a block diagram illustrating an example of communication between electronic (client) devices 110 (such as a cellular telephone, a portable electronic device, or another type of electronic device, etc.) in an environment 106. Moreover, electronic devices 110 may optionally communicate amongst one another and/or with the server computer system 130 via a cellular-telephone network 114 (which may include a base station 108), one or more access points 116 (which may communicate using Wi-Fi) in a wireless local area network (WLAN) and/or radio node 118 (which may communicate using LTE or a cellular-telephone data communication protocol) in a small-scale network (such as a small cell). For example, radio node 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node, or a base station are sometimes referred to generically as a communication device. Moreover, one or more base stations (such as base station 108), access points 116, and/or radio node 118 may be included in one or more networks, such as: a WLAN, a small cell, a local area network (LAN) and/or a cellular-telephone network. In some embodiments, access points 116 may include a physical access point and/or a virtual access point that is implemented in software in an environment of an electronic device or a computer.

Furthermore, electronic devices 110 may optionally communicate with computer system 130 (which may include one or more computers or servers, and which may be implemented locally or remotely to provide storage and/or analysis services and may be programmed with any one of the ML models described herein) using a wireless or wired communication protocol (such as Ethernet) via network 120 and/or 122. Note that networks 120 and 122 may be the same or different networks. For example, networks 120 and/or 122 may be a LAN, an intranet, or the Internet. In some embodiments, the wired communication protocol may include a secured connection over transmission control protocol/Internet protocol (TCP/IP) using hypertext transfer protocol secure (HTTPS). Additionally, in some embodiments, network 120 may include one or more routers and/or switches (such as switch 128).

Electronic devices 110 and/or computer system 130 may implement at least some of the operations and/or ML models using the techniques described herein. Notably, as described further below, a given one of electronic devices (such as electronic device 110-1) and/or computer system 130 may perform at least some of the analysis of data associated with electronic device 110-1 (such as first detection of a new peripheral, communication via an interface, a change to software or program instructions, a change to a DLL, a change to stored information, etc.) acquired by an agent executing in an environment (such as an operating system) of electronic device 110-1, and may provide data and/or first-detection information to computer system 130.

In some embodiments, the computer system 130 represents a server computing system while electronic devices 110 represent client computing systems. In some embodiments, the computer system 130 represents a client computing system while electronic devices 110 represent server computing systems. Any or all of computer system 130 and electronic devices 110 may be programmed with one or more ML models described herein.

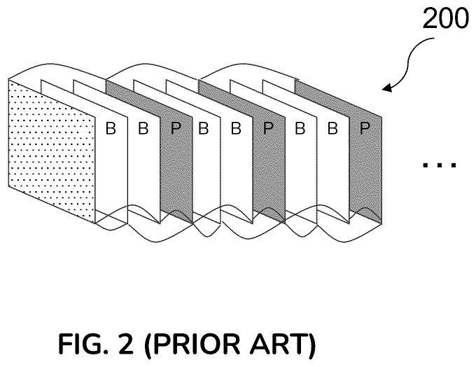

FIG. 2 is an example video compression frame sequence 200 generated by a conventional compression algorithm. For example, such a conventional method involves compressing data or information on the server and sending the compressed data to the client device. In general, existing compression algorithms known in the art are between a client device and server, where the server compresses the streams of information, and the client device decompresses the information. The compression algorithm, for example, an MPEG compression algorithm generated video compression frame sequence 200 is shown in FIG. 2. The video frame sequence 200 is generated by the server and sent to the client device. In this example, the server is an encoder and the client device is a decoder. The frame sequence 200 generated by the MPEG compression algorithm includes three types of frame sequences including an I-frame, a P-frame, and a B-frame. Such a compression ensures that both the server and the client are capable of fully executing and rendering when content is decompressed and does not allow for offloading client side processing back to the server.

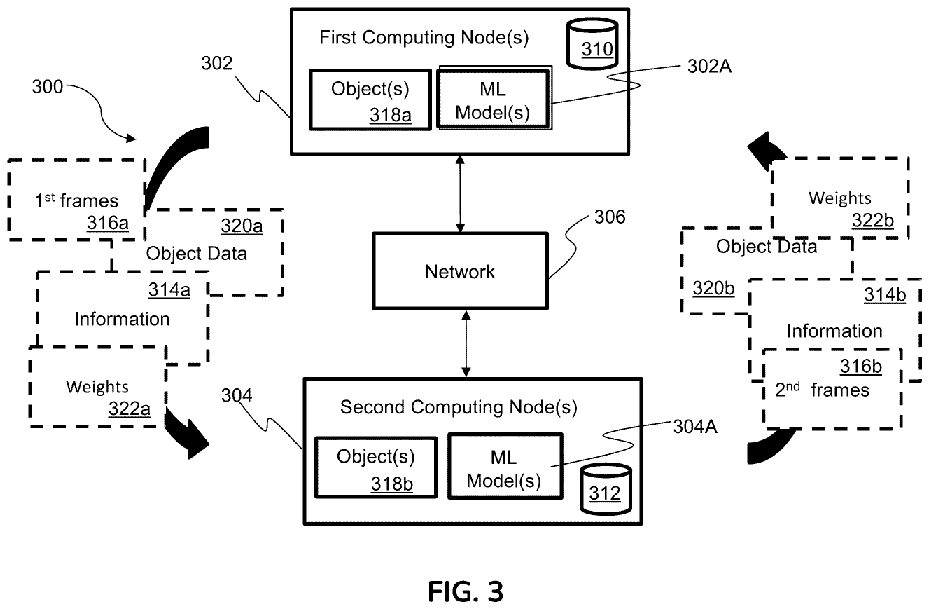

FIG. 3 illustrates an example system 300 for generating content in a simulation environment. The simulation environment may be a gaming environment, an online environment, a distributed and/or shared environment, a virtual reality environment, an augmented reality environment, a training environment, a virtual machine generated environment, a machine learning training environment, a machine learning environment, or any combination thereof. The environment may be for a single user or for multiple users. The environment may be presented to any number of users to generate and provide content. The environment may allow for user interaction with the environment and with other users.

The system 300 may communicate using a distributed learning and activation model amongst one or more clients (e.g., client devices 110) and one or more servers (e.g., server computing device 130). The system 300 represents a peer-to-peer (P2P) computing network that includes a first set of computing nodes 302 and a second set of computing nodes 304. The computing nodes 302, 304 may be in communication with one another via a network 306. The first computing nodes 302 manage a first set of ML models 302A and the second computing nodes 304 manage a second set of ML models 304A. The first computing node 302 and the second computing node 304 may provide timely information to update a model that may be (or is currently being) dynamically learned. The timely information may represent information that is received within a window of time that is deemed valid by the system 300. For example, the system 300 may define a window of time in which information remains valid. Before or after the defined window of time, the information may be deemed by the system 300 as no longer timely (e.g., deprecated, outdated, etc.). Thus, the systems described herein may reject (or not use) information that is deemed untimely.

In some embodiments, the first computing node 302 and the second computing node 304 variably update the ML models 302A, 304A. The updates may be performed independently from network delays, packet drops, packet errors, etc. Each ML model 302A, 304A may include one or more artificial intelligence (AI) modules to analyze and communicate information between the first computing node 302 and the second computing node 304. While two computing nodes are depicted in FIG. 3, one skilled in the art may contemplate any number of nodes having respective sets of ML models, and such nodes may also be in networked communication with one another as well as with computing node 302 and computing node 304 through network 306.

In some embodiments, the system 300 may include one or more databases (e.g., database 310, 312, etc.) in communication with the computing nodes 302, 304 for storing timely information, image data, video data, metadata, instructions, computer code, or the like.

In some embodiments, the first computing node 302 is a server, and the second computing node 304 is a client device. For example, the first computing node 302 may be referred to as the server, and the second computing node 304 may be referred to as the client device. The client device (e.g., node 304) may be associated with a user. Alternatively, the client may function as the server, and the server may function as the client device. For example, node 304 may function as a client device in one interaction in the system 300, but may function as a server in another interaction in the system 300. Similarly, node 302 may function as a server in one interaction in the system 300, but may function as a client device in another interaction in the system 300.

Each server (e.g., node 302) may include one or more computing devices having one or more processors (not shown) for executing program instructions. In some embodiments, the processors may include graphic processors for rendering and generating graphics, images, video, audio, and/or multimedia files. The server also may include memory for storing the program instructions and data that is used and/or generated by processes being carried out by the server under direction of the program instructions. The client device (e.g., node 304) is generally a computer or computing node including functionality for communicating (e.g., remotely) over network 306. The client device includes one or more processors (not shown) for executing program instructions. In some embodiments, the processors may include one or more graphic processors for rendering and generating graphics, images, video, audio, and/or multimedia files. The client device may also include memory for storing the program instructions and data that is used and/or generated by processes being carried out by the client device under the direction of the program instructions.

The P2P network of system 300 represents an example decentralized and distributed network architecture in which individual computing nodes (e.g., nodes 302, 304, etc.) in the network 306 may act as both server and client device, in contrast to a centralized client-server model in which client nodes request access to resources provided by central servers or master nodes. The P2P network may share tasks performed by the system 300 amongst multiple interconnected computing nodes (e.g., nodes 302, 304), each of which may provide a portion of their resources (e.g., processing power, disk storage, and/or network bandwidth) to other network participants, without the need for centralized coordination by servers or master nodes.

The client device (e.g., node 304) may be a desktop computer, laptop computer, personal digital assistant (PDA), smart phone, or mobile gaming device. The client device may execute one or more client applications, such as a web browser to access and view content over a computer network. The client device may be associated with a user.

The network 306 communicates data between the client devices and servers. The network 306 may represent the communication pathways between the server (e.g., node 302), client device (e.g., node 304), and any other entities. In some embodiments, the network 306 may be the Internet implementing communications technologies and/or protocols. Thus, the network 306 can include links using technologies such as Ethernet, worldwide interoperability for microwave access (WiMAX), 3G, long term evolution (LTE), digital subscriber line (DSL), asynchronous transfer mode (ATM), InfiniBand, PCI Express Advanced Switching, etc. Similarly, the networking protocols used on the network 306 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 306 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. The system 300 may also use custom and/or dedicated data communications technologies instead of, or in addition to, the technologies described herein.

In some embodiments, the system 300 may be executed in a simulation environment. The simulation environment may provide a user with a flexible interface to an online gaming system, a distributed gaming system, or other local or distributed programmable system with which the user may interact. The simulation environment may provide for discrete event simulation, dynamic simulation, and/or ad-hoc simulation tasks. In some embodiments, the system 300 may function to generate and/or render objects and entities within the simulation environment as well as generate and/or render conditions, characteristics, behaviors, or other features of the simulation environment.

In general, the entities, conditions, characteristics, behaviors, or other features of the simulation environment may be generically referred to as an object herein, unless the context indicates otherwise. Example objects may include, but are not limited to, digital objects, virtual objects, graphical objects, video objects, acoustic objects, rendered physical objects, etc.). Objects may be any representation of animate or inanimate content, including but not limited to, buildings, plants, vehicles, people, animals, creatures, machines, data, video, audio, text, pictures/images, and other users. Objects may also be defined in the simulation environment for storing information about items, behaviors, or conditions actually present in the physical world. The data that describes or defines the entity, object or item, or that stores its current state, is generally referred to herein as object data. Objects may also include large-scale physics events, for example, movements, fires, and tornados, or the like.

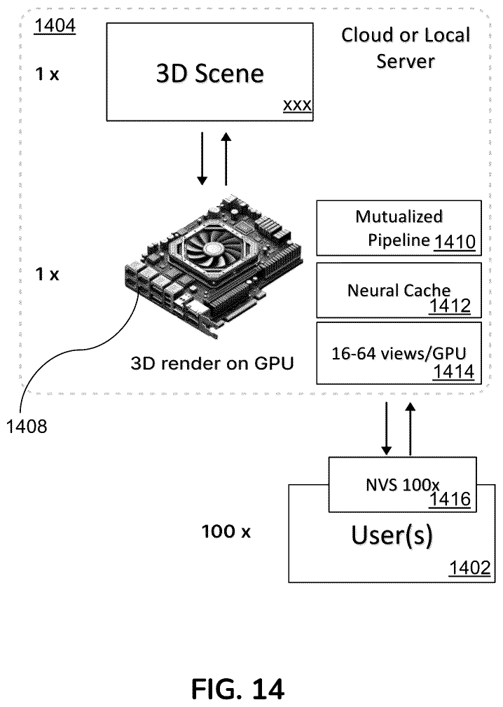

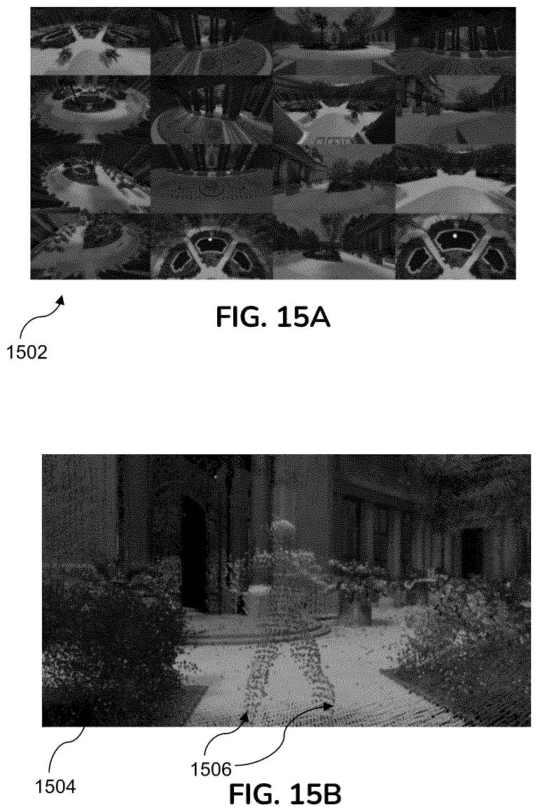

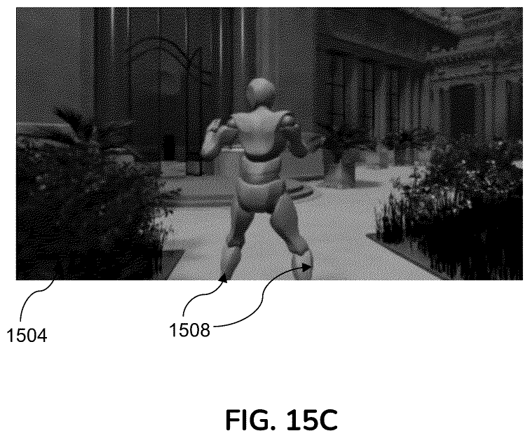

The first computing node 302 may include or represent any number of nodes that may manage a first set of ML models 302A. The second computing node 304 may include or represent any number of nodes that may manage a second set of ML models 304A. The first computing node 302 may share or exchange timely information (e.g., information 314a, 314b) with the second computing node 304. The information 314a, 314b may dynamically update ML models 302A and ML models 304A to allow for mutual learning between two or more of the nodes 302, 304, etc. within system 300, as described in FIGS. 14-15C herein.

In operation, the first computing node 302 (e.g., functioning as a server) may determine/identify a sequence of first frames 316a of at least one object 318a to be rendered for a simulation environment associated with system 300 (a computing device communicatively coupled to network 306). The sequence of first frames 316a may be associated with object data 320a and/or weights 322a. Concurrently or sequentially, the second computing node 304 (e.g., functioning as a server) may determine/identify a sequence of second frames 316b of the at least one object 324 to be generated and rendered for a simulation environment associated with system 300 (a computing device communicatively coupled to network 306). In some embodiments, the client device and the server may act as a computing node (302, 304) to form a peer to peer network.

Object data 320a, 320b may represent information about one or more objects 318a, 318b. Weights 322a, 322b may represent an ML model generated weight for a particular object, shard, frame, and/or prediction performed by the ML models 302A and/or ML model 304A. In some embodiments, the first frames 316a from the server may be intraframes, and the second frames 316b from the client device may be mainframes. The first frames 316a may refer to a significant frame to render a particular object, and the second frames 316b may refer to a delta change between the significant frames. The first frames 316a may also be referred to as a mainframe (“M” frame), and the second frames 316b may also be referred to as intraframes (“i” frames). A mainframe received from the client device (e.g., node 304) may be referred to as an “R” frame.

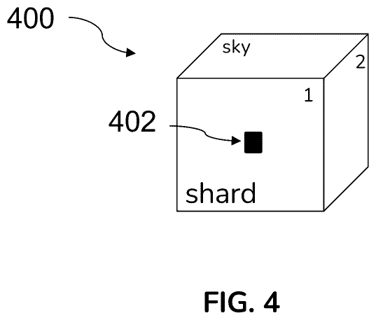

In some embodiments, the system 300 may be executed in a simulation environment (e.g., a computing device or executable environment communicatively coupled to network 306) or may generate the simulation environment for execution. The simulation environment may be formed of a number of shards that may be used to present information to a user on a computing device. The first computing node 302 may generate at least one shard 400 (shown in FIG. 4) for each user. Each shard 400 defines at least a portion of the simulation environment and each shard 400 encapsulates one or more volumetric spaces. In some embodiments, each shard associated with at least one of a plurality of users may define the simulation environment. The volumetric space of the shard 400 may be represented as an enclosed volume formed by a plurality of walls.

In some embodiments, the clients (e.g., users) residing in the same shard with the same dimensions and spatial shape may have different objects 318a, 318b inside their respective shards. The system 300 may dynamically vary the physical and logical attributes of the shard including the location of the shard at the simulation environment and at least one characteristic of the shard by at least one of the client device (e.g., node 304) and server (e.g., node 302). The characteristics of the shard may include one or more of: dimension, shape, content, location, rendering, and control responsibilities. Dimension may be the 3D physical and logical dimensions. Shape may indicate a 2D or 3D and/or size and shape to the shard including, but not limited to a square, a cube, a circle, a sphere, a polygon or 3D polygon, and the like. Location may be a location in the scene relative to some coordination map. Content may be the image content and related data of a scene, which object and/or which assets are included to render the scene correctly. Rendering may include rendering assets including AI renderer. Control responsibilities include, but are not limited to, frequency of updates and exchanging or sending information between the server device to the client device and client device to the server device. Further, the location of the shard may be determined by the server (e.g., node 302) and communicated to the client device (e.g., node 304).

In some embodiments, the shard may be a dynamic shard, e.g. the shard is not predefined but is instead determined at run time based on client, server, and network interface logical and physical performance characteristics. In some embodiments, the shard can be a static shard, e.g. a shard that is set in the system and with limited characteristics that can be changed at run time. In some embodiments, the shard may represent a physics simulation and physical attributes-based shard. The volumetric space of the shard is an enclosed volume formed by a plurality of edges. The volumetric space can include a volumetric space in the simulation or as a volumetric part of the simulation environment. Although a shard is depicted in this disclosure as a cube (FIG. 4), a shard enclosure is not limited to a cube but can be any spatial three-dimensional shape.

In some embodiments, one or more shards may be assigned to a user. The shards assigned to a user can be overlapping, (e.g., more than a single shard being assigned to the same volumetric space and coordinates). Shards in the same space may include the same objects 318a, 318b or different objects. In some embodiments, a shard may be an acoustic shard. An acoustic shard is an example of using multiple shards overlapping in a similar 3D space and coordinates to provide particular sound content.

In a non-limiting example, each computing node 302, 304 includes a machine learning (ML) model (e.g., 302A, 304A, respectively) for each shard 400. The ML model 302A, 304A may be used to determine the objects 318a, 318b to be generated at the simulation environment. The computing nodes 302, 304 may update weights 322a, 322b associated with instances of the ML models 302A, 304A. For example, lighting information, regarding an object, changes the way the system renders this object inside a given scene. When lighting information changes on either of the computing nodes, the weights may be updated to reflect the new information using system 300.

In some embodiments, the first computing node 302 and the second computing node 304 may negotiate to determine when and/or how to render content in the simulation environment. Alternatively, at least one second computing node 302 may render within each shard 400 and at least one second computing node 304 may render outside the shard 400, for example, an adjacent shard 400 or an environment outside a particular shard 400. In some embodiments, the object includes a video stream. The first computing node 302 may stream an environment outside of the shard 400 as a video stream at the walls of the shard 400. For example, video compression is used to stream the videos. When render requirements increase beyond the capabilities of the client device, the server may assist with operations to render content in the world (e.g., simulation environment) inside the shard. Further, communication bandwidth limitation may dictate a particular effort of distribution of data and/or content between the client device and server.

Further, each computing node 302, 304 may dynamically update the first and second frames 316a, 316b depending on a change in the simulation environment. Each computing node 302, 304 may dynamically update the first and second frames 316a, 316b of each shard 400 to correspond to the environment outside of the shard 400. For example, a moving object outside the shard may drop shadows into the shard 400, which in turn impacts static and dynamic object rendering inside the shard. In another example, when another object from outside the shard 400 enters the shard due to dynamics in the environment outside the shard, the entry may cause additional information to be sent to the client including a new ML model for drawing this new object within the shard 400.

Further, the system may dynamically render the shards 400. For example, an increase in the number of players in the environment, also increases the number of events exponentially between clients and the rendering complexity increases. The system 300 may limit a rate (frequency) and bandwidth (size) of information (e.g., content) transmitted between the server and the client device. The frequency may be dropped to a few times per second while allowing for a full 60 or 120 frames per second to be rendered on the client device. In short, the system 300 may allow ML training to execute on the server and the rendering of the simulation environment to execute on the client device using the prior training. In some embodiments, the client devices may share particular training, updates, and rendering instructions without utilizing the server device.

The system 300 may also train an ML model for each shard 400 and object within the shard 400 to minimize the model size. After training, the server shares the weights (e.g., weights 322a, 322b) with the client device in large intervals, and the client device executes the ML model (e.g., ML model 302A or 302B) locally for each frame, or as needed. For example, the ML model may use NeRF (Neural Radiance Fields) to generate/draw static objects in a scene. Such models can generate high quality 3D objects in a scene in a simulation environment. In some embodiments, the ML models described herein may be trained on objects and data from existing databases and/or prior versions of model output. In some embodiments, the ML models described herein may also handle dynamic changes to the environment in a scene. The training stages can be broken down to allow the client side to handle the final stage and to light the simulation. The lighting may depend on the current light state of the client device. The last stage of the lighting may be client dependent and can be handled locally without overuse of resources.

The system 300 may be implemented in a multi-user environment, for example, a game environment or a simulation environment. The multi-user environment includes one or more client devices. The client device may be associated with a user. The system 300 may further include one or more servers. At least one server is in communication with at least one client device through a network 306. The system 300 may further include one or more databases 310, 312 (or other database in communication via the network 306). In some embodiments, the databases may include information related to a plurality of simulation environments. In some embodiments, the client device may execute the functionality of the server and/or the server may execute the functionality of the client device.

The databases 310, 312 (or other database in communication via the network 306) may further include information to generate the simulation environment. For example, the information may include, but is not limited to, atmospheric data, terrain data, weather data, temperature data, location data, and/or other data used to define and/or describe the content within or associated with the simulation environment. Additionally, the database may further include data defining various conditions that govern the operation of the simulation environment. Such data may include, but is not limited to, laws of physics, time, spatial relationships, and/or other data that may be used to define and/or create various conditions that govern the operation of the simulation environment.

The server (e.g., node 302) may render and send the first frames 316a to the client device. The client device may render the second frames 316b. In some embodiments, the second frames 316b may include minor environmental changes and local adjustments to view the object or model.

The server may generate at least one shard 400 (shown in FIG. 4) for each user. Each shard 400 defines at least a volumetric shard (three-dimensional (3D) space and/or an acoustic shard, which is a volumetric space for acoustic dissipation and forms at least a portion of the simulation environment). The server and client device may negotiate and render at the simulation environment. For example, in a case of 60 frames per second, one mainframe comes from the server. The mainframe from the server is rendered down to high quality. The mainframe from the server is to the client, which is displayed to the user. The next phase of frames with minor changes are calculated and rendered by the client device. The client device is responsible for the minor changes in the environment and simulation/gameplay relative to the main frame that was previously generated and sent from the server. These minor changes may be generated locally by the client device.

This allows a large portion of the processing load to be placed on the server, and the minor rendering load is placed on the client device. Further, the processing load on the server is infrequent and allows for an increased performance advantage. Additionally, the server may forego the process of sending 60 frames per second or more. Thus, the bandwidth usage on the network is advantageously reduced.

Referring to FIG. 4, the shard 400 is shown here as a small cube (e.g., box) where a player 402 is positioned substantially in the center of the shard 400. In this example, a number of objects rendered by the client device (e.g., node 304) may be relatively small. The simulation environment, for example, a game environment could be divided into a plurality of shards 400. In some embodiments, the shard 400 can define a transparent box. In general, a shard may house a player and a world may be rendered within the box. The world (e.g., environment) outside the box may be projected as a video on the outside walls (e.g., wall 1, wall 2, etc.) of the shard 400.

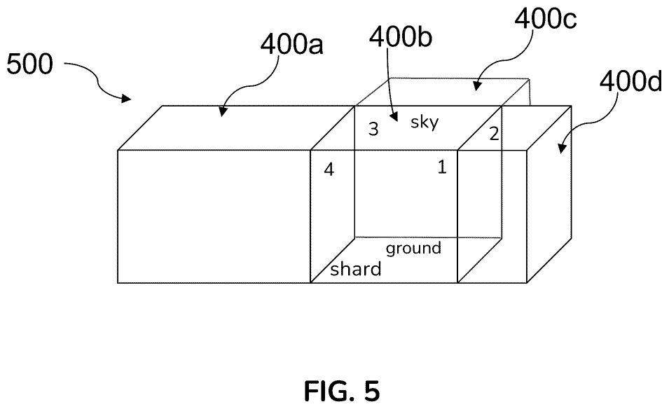

Referring to FIG. 5, an environment 500 that includes a plurality of shards 400 (e.g., 400a, 400b, 400c, 400d) is depicted. The plurality of shards 400 together form at least a portion of the game environment 500. The world outside each shard 400a, 400b, 400c, 400d, for example, may be projected on the walls of the respective shard. Each shard may have six surfaces, as shown enumerated here as wall 1, wall 2, wall 3, wall 4, sky, and ground.

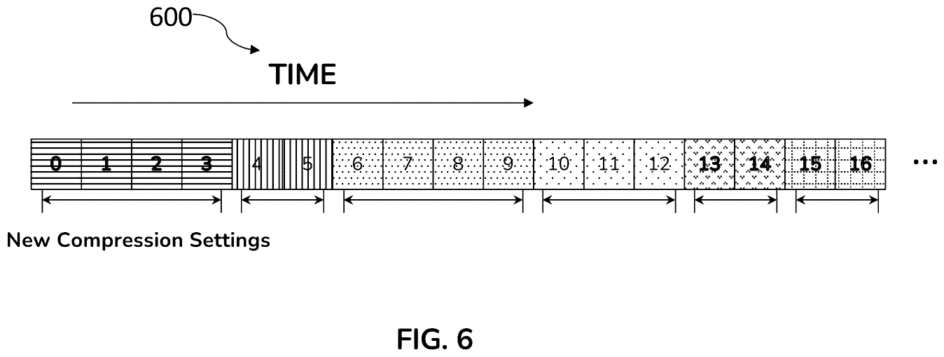

FIG. 6 exemplarily illustrates a model 600 of an example frame sequence that may be sent from a server to a client device. The frame sequence may represent a sequence of first frames 316a. In operation, the sequence of first frames 316a may be sent to the client device (e.g., node 304) from the server (e.g., node 302). The server may dynamically change the structure and content of the first frames 316a based on one or more requirements of the simulation environment. The cross hatching shown in FIG. 6 represents a frame type. In this example, each change in cross-hatching from left to right represents a new main frame. The numbers 0-16 in each frame represent different content in each respective frame.

For example, consider a simulation running on the server and the client device. The server may simulate a different view of the simulation than the client device. Thus, the server may update the client device with new information which results from the differences in differing points of view, for example, amongst new mainframes that are part of the simulation. In addition, each client device may render a simulation environment and each of the respective simulation environments may be updated similarly or differently by the server.

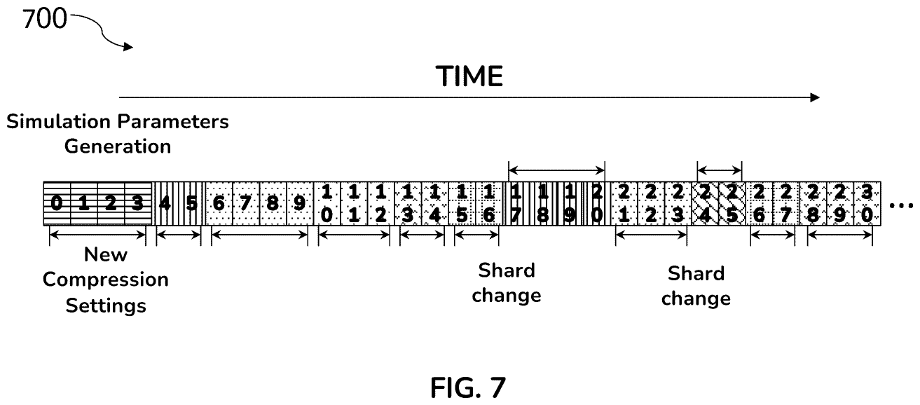

FIG. 7 exemplarily illustrates a model 700 of an example frame sequence sent from the server to the client device when a client device moves to a different shard 400. Referring to FIG. 7, the model 700 of the frame sequence depicts shard changes that impact the compression setup. For example, the system may simulate a gaming environment, for example, a 3D environment that is divided into shards 400 or areas and/or volumes of simulation. The client device (e.g., node 304) may include and execute an ML model (e.g., ML model 304A) for the specific shard 400 and its contents and can render/display the shard 400b in a 3D world. When a shard changes, e.g., the user is typically moving to a different shard (e.g., 400a), and in response, the server (e.g., node 302) may trigger an update to the ML model 304A and any accompanying weights 322b to reflect the new shard 400a simulation correctly. When moving between shards, the focus may be moving between two separate scenes. Some of the objects in the first scene could be part of the new shard and many objects will be new. For each object in the new shard, the client may receive ML models to help it render this object correctly in the scene. Similar to the example of NeRF model described above for objects inside a shard, the server node can update the client device with the ML models and expect the client to finalize the drawing.

Shard changing may be a single example of the use of compression. Between updated frames sent to the client device by the server, the client device continues to generate its own frames and, in the case of a 3D simulation, presents those frames to the user. By using this method, the client device is semi-independent of the server-to-client bandwidth and the dynamic change in network availability. For example, when a mobile device is performing a handoff between two networks, there may be a delay and jitter that impacts performance. By disassociating the client device and server or reducing the bandwidth requirement, the client device may continue rendering and/or perform other modifications to the frame until the next frame comes from the server.

In some embodiments, the client device may update the server in the same way that the server could update the client device, e.g., frames between the client device and the server go both ways, as shown in FIG. 3. The rate of a frame sent by the client device to the server may be lower than the simulation frame on the client device. The rate of the frame being sent from the server to the client may be lower than the actual frame rate on the server.

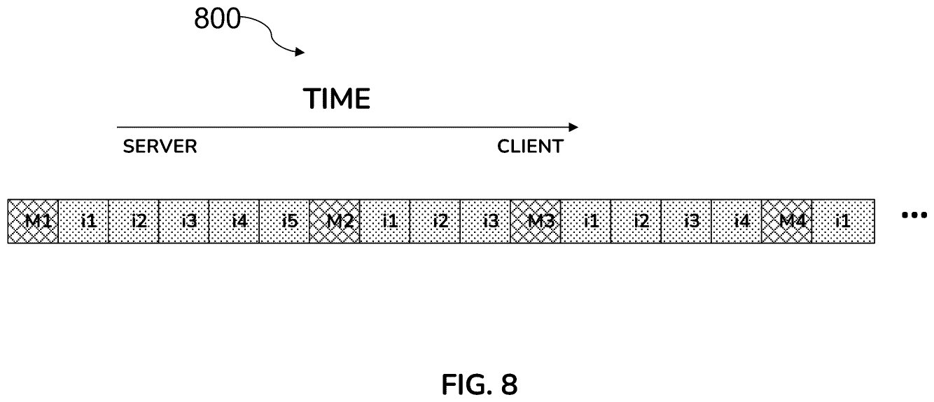

FIG. 8 exemplarily illustrates a model 800 of a set of frame sequences sent from the server to the client device. The “M” frame refers to the mainframe and the “i” frame refers to intraframes. The number of intraframes is variable between M-frames, and the frequency and content of the M-frame may change, as depicted in FIG. 7. The i-frames may occur independent of the communication from the server to maintain the client's high frame rate. The client device may have independent learning associated with the dynamics of the simulation, which enables the client device to send frames back to the server. For example local light orientation changes, or movement of an object inside the scene, or changes in the makeup of an object due to physics simulation may be sent from the client device to the server.

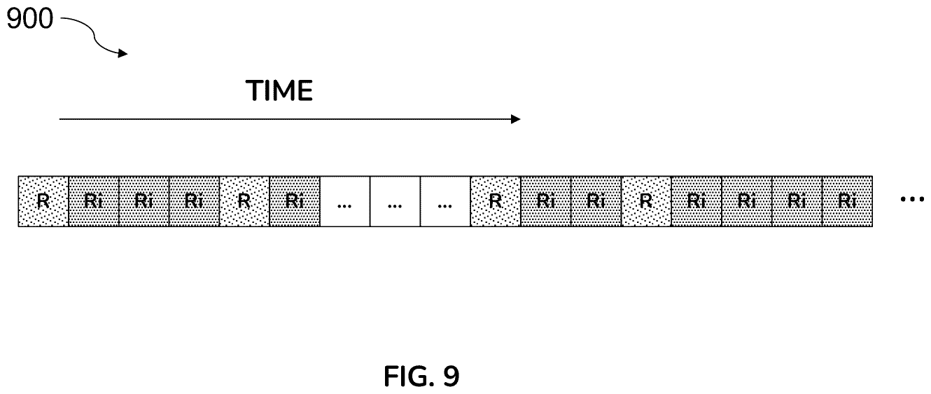

FIG. 9 exemplarily illustrates a model 900 of a set of frame sequences sent from the server to the client device. “R” frames are reverse mainframes from the client to the server to allow for major updates, while the “Ri” frames are for intermittent updates that the client may send to the server. The Ri frames refer to reverse intraframes. Both types of frames from the client device to the server occur on a variable frequency and dynamic scale depending on the environment and the simulation required updates.

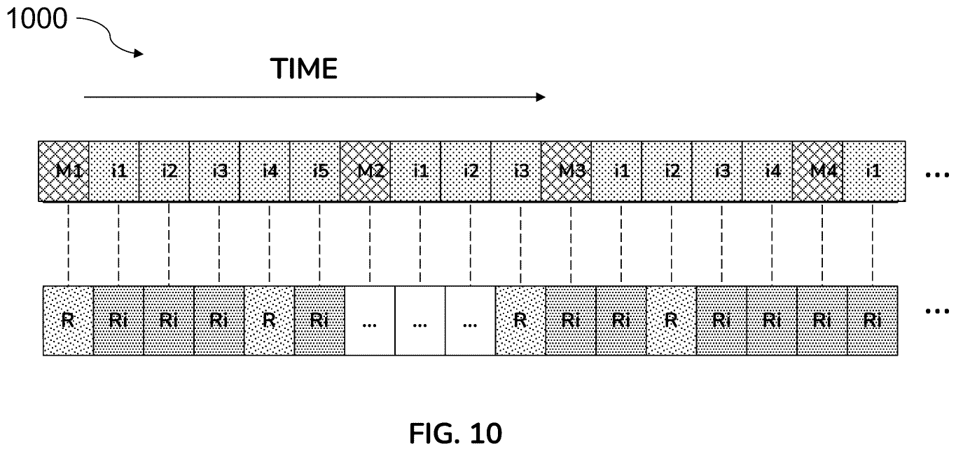

FIG. 10 exemplarily illustrates a model 1000 including a frame sequence of R/Ri-Frame mapped to M/i-Frame to render objects in the simulation environment. In an example, the client device and the server may execute a simulation. The client device and the server may depend on each other to provide periodic updates on weights (e.g., weight 322a, 322b) and ML model specifics in order to tune the results of the simulation. In this case, the server may run a larger view of the model and the client device is running a sub-view of the system.

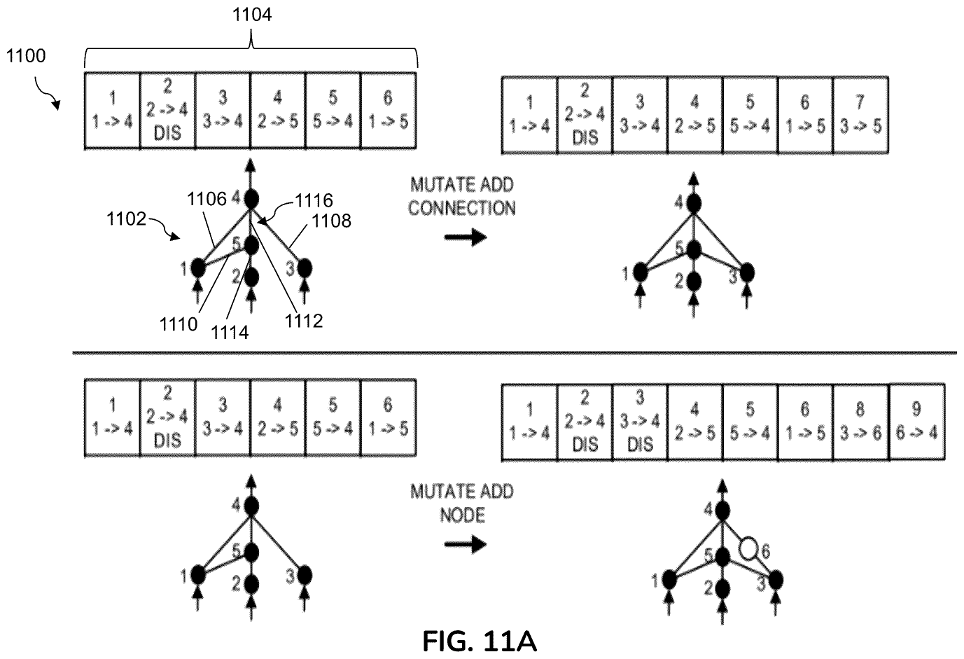

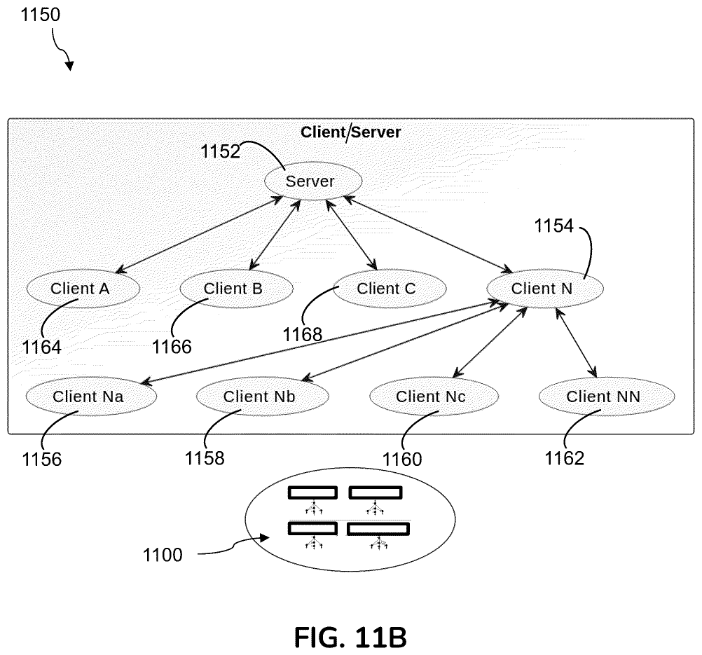

In operation, the server (e.g., a first computing node 302) and/or the client device (e.g., a second computing node 304) may receive at least one of the first frames 316a and the second frames 316b. The server may then correlate and map the first frames 316a with the ML model 304A and update the weights in this model to render at least one object in the simulation environment. For example, a server device with available computational resources can update an ML model and communicate the model to the client, while later communicating a new set of weights as the server device is learning more information. Another example, correlating the first frames 316a with the ML model 304A and updating the weights in this model is described in the NEAT ML model example for FIG. 11A. In this case, the NEAT ML model allows for two phenotypes (e.g., networks) to be integrated into a single model that retains the knowledge of both phenotypes.

In some embodiments, the ML model 302A and/or the ML model 302B may determine at least one object to be rendered at the simulation environment. For example, after comparing two Phenotypes, the changes could be minimal, thus not triggering any updates to the rendered object(s), while in other cases, the difference between two (or more) Phenotypes can be more profound and thus may trigger updates to the rendered object(s). Communication of updated models, e.g. Phenotypes in the example of FIG. 11A, can depend on changes, like additional nodes or weights change.

FIG. 11A is a block diagram of an example ML model 1100 based on Neuro Evolution of Augmented Topologies (NEAT). The ML model 1100 represents a neuroevolutionary model that includes at least one network that may be evolved based on competition between populations of neural networks (NNs) trying to achieve a particular goal (or set of goals). The ML model 1100 may use direct encoding to specify the structure of the NN. For example, using direct encoding, the systems and methods described herein may specify each gene to be represented in the model. In particular, each gene may be directly linked to at least one node, connection, or property of the NN. In some embodiments, the encoding may be a binary encoding of ones and zeros. In some embodiments, the encoding may be a graphical encoding to link nodes by weights, for example.

As shown in FIG. 11A, a node tree 1102 includes an array 1104 representing a series of nodes 1, 2, 3, 4, 5, and 6 and connections 1106, 1108, 1110, 1112, and 1114 (i.e., connection 1112 combined with connection 1114). The array 1104 may represent a first iteration before a mutation occurs. The connections represented in array 1104 indicate a node in which a connection begins and a node in which the connection ends. In some embodiments, one or more weights (not shown) may also be included in the array 1104. In some embodiments, one or more additional indicators may be included in the array 1104.

The evolution may be executed every epoch and is controlled by a predefined set of rules. Adding a neuron or a connection and the weights assigned are randomly selected with certain probabilities which structure the evolution, while maintaining species and managing genetic encoding that allow for two phenotypes from different species to mate and produce an offspring that includes desired (e.g., preselected, ideal, best, etc.) characteristics of both parents. This last step of mating and producing an offspring that is the strongest desired features of both parents can be a basis in which to send/trigger updates to a model by the client or the server and as a basis in which to update the model by mating the received model with the current model, as described in FIG. 3.

FIG. 11B is a block diagram of an example machine learning model 1150 for use with the simulation environments described herein. In this example, a client/server system is depicted as a tree of nodes and connections with the assumption that each node is a server of a client, and the client is also a server 1152 to other clients. Each node is capable of communicating amongst each other at a frequency depending on the event or occurrence of a particular event at the client that is triggered by a user or a simulated user. These events can cause changes in the simulation environment that will be learned by the client (e.g., node 304) and once learned will be communicated to the server (e.g., node 302, devices 110, etc.). Meanwhile, the server may continue to integrate learnings from multiple clients and communicate the accumulated knowledge back to the participating clients. The communication between the clients and the servers may be at a low frequency relative to the learning executed within each client. Clients (e.g., client N 1154) which act as a server to other clients that may communicate accumulated knowledge to the server 1152 at the root of this tree of nodes as well as down to their clients (e.g., client Na 1156, client Nb 1158, client Nc 1160, and/or client NN 1162, etc.). Server 1152 may act as a server to other clients that may communicate accumulated knowledge to client 1164, client 1166, client 1168, and/or client 1154.

In a non-limiting example, a city may be divided into blocks. Each block is a shard and different clients may be in various shards, some in the same shards and others distributed amongst the shards. A physics simulation may be executed that causes an event triggering a wave of buildings to collapse and the event moves in a specific direction at a specific speed which is controlled by a set of physics laws. Ahead of the event, the server 1152 may distribute an ML model that governs buildings and other objects in a shard to each client, yet one can see that once the event arrives at a shard location, the events in the shard itself are complex and difficult to model exactly, thus locally, each client device (e.g., client Na 1156, client Nb 1158, client Nc 1160, client NN 1162, client 1164, client 1166, client 1168, and/or client 1154) may be arranged to handle its own view of the physics and what is happening inside the shard while updating the ML model (e.g., ML model 304A) to reflect the shards physics and communicate these updates to the server. The server in turn will update the ML model (e.g., ML model 302A at the server node 302) and focus on physics/events/communications/information occurring between shards and changes in the event trajectory and force vectors. Thus, the server (e.g., node 302, 1152) can handle the border (inter-shard) information while the clients (e.g., node 304, client 1156, etc.) handle the intra-shard events and information.

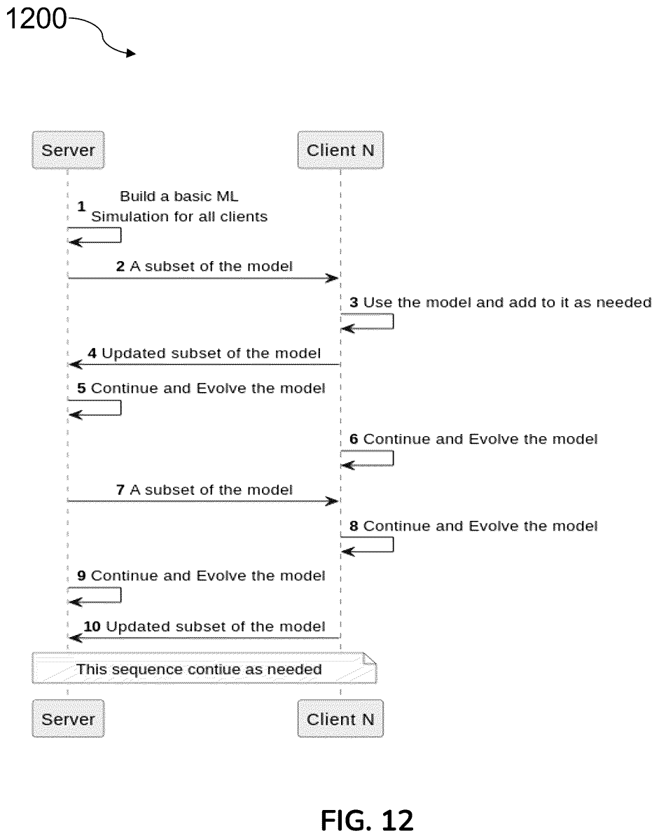

FIG. 12 is a flow diagram of an example process 1200 for facilitating a distributed learning and activation model for a machine learning program in an environment for use with the simulation environments described herein. The process 1200 represents the events and information flow between a server and one or more clients. In this example, the term “client N” may represent all clients.

In step 1, the server builds and trains a basic ML model to be distributed to one or more of the clients (e.g., client N) depending on the client specifics. The NEAT base model may be employed in this example. The client may maintain a model specific to a particular shard while the server has a view of all shards as well as a view of the borders between the shards.

In step 2, a client receives a subset of the model as an input and allows the simulation to operate inside of the client as depicted in step 3. The client may use, update, and/or add to the model over time. In step 4, the client communicates any updates or additions to the model back to the server which may continue to process changes to the model based on this input and other client inputs. These changes, as they impact specific clients may in turn communicate back to the specific clients. The sequence of updating and exchanging subsets of the model may continue as clients update (e.g., modify, evolve, etc.) the model, as shown in steps 5, 6, 7, 8, 9, and 10, etc.

In some embodiments, a change generated by a client device may destroy parts of one or more shards. In such an example, the client server interaction will dissipate over time and the affected one or more shards may become stable, which can result in removal of the specific model that destroyed the parts of the one or more shards. Further, since the process 1200 communicates changes to the model over time, at some point in time, there are no more changes in the model and thus no further communication between the server and clients.

As described in the examples herein, each client device may be configured with a different machine learning model, while the server maintains a global view of all of the machine learning models being utilized on each client. The server may send updates to a client based on this specific situation and ML model. The client may also send updates to the server regarding changes that the client makes to the ML model t. The client device could have a specific ML model and could send updates back to the server. The client device may choose an ML algorithm based on hardware capabilities of the client device. The server may track the ML model running on the client device. Alternatively, the client device may inform the server on a reverse link for changes to the ML model currently running every few frames. Further, the client device may change performance requirements and request for a different ML algorithm to match the new performance parameters.

In general, the choice of which ML model to use for a specific client is based on the shard that the specific client operates in. The server may divide a simulated world into shards. A client can be in a single shard. A client has real-time events associated with these shards being generated locally to the client, thus the client continues and trains its subset of the model to reflect these changes in its own simulated reality. The new updates to the client model can be communicated to the server. For example, when the system uses an ML model per object inside a shard, the system chooses the model based on the object and the shard physics and lighting as well as resolution requirements associated with the object.

Advantageously, the system reduces computational effort on the server while reducing bandwidth between the server and the client device. For example, as described above, the server can focus computation on changes between shards (inter-shard changes) while local clients can focus on the changes and updates based on events inside the shard. The rendering rate of the server may be reduced because the server may render particular frames based on inter-shard changes, but need not render every frame in the simulation environment. As the rendering rate is relatively low, the server could handle multiple simulations simultaneously and increase the cost-effectiveness ratio. The client device may render a delta of any changes between the significant frames, which may reduce the computing power of the client device.

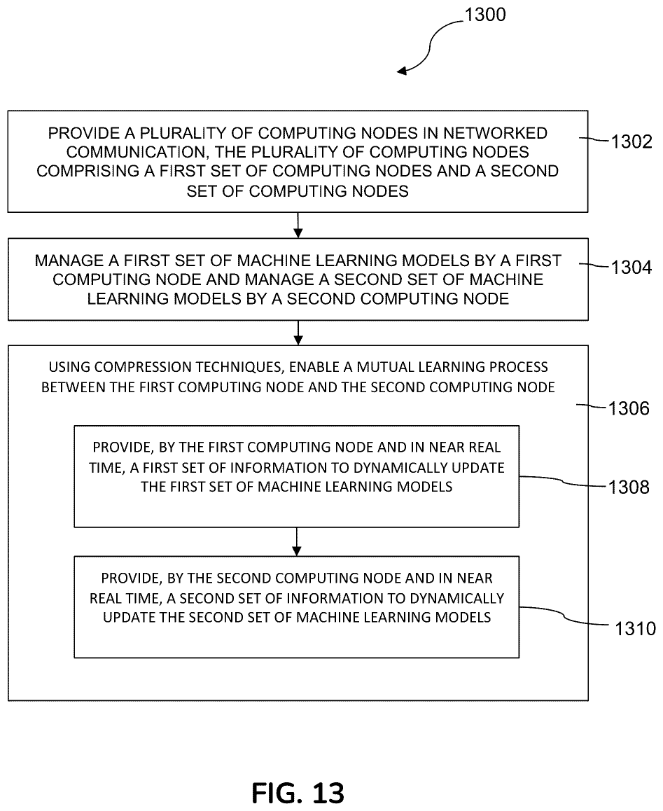

FIG. 13 is a flow diagram of an example process 1300 for facilitating a distributed learning and activation model for a machine learning program in an environment. The process 1400 may be described using the example components of system 300 (FIG. 3). One skilled in the art will appreciate that other components and/or duplicative components to system 300 may also be used to carry out the steps of the process 1300.

At step 1302, the process 1300 includes providing a plurality of computing nodes in networked communication. For example, a first set of computing nodes 302 may be in networked communication (via network 306) with a second set of computing nodes 304. The nodes 302 may represent one or more servers that may provide updates and information to one or more client devices, such as nodes 304.

At step 1304, the process 1300 includes managing a first set of machine learning models (e.g., ML models 302A) by the first computing node 302. For example, the computer system 130 may represent node 302 and may determine when to execute and/or update ML models 302A before, during, and/or after communicating with node 304 (e.g., client device 110). The communication may include frame data, information 314a, object data 320a, weights 322a, or the like. The process 1300 may also include managing a second set of machine learning models (e.g., ML models 304A) by a second computing node 304 (e.g., client device 110).

At step 1306, the process 1300 includes enabling a mutual learning process between the first computing node 302 and the second computing node 304. For example, the process 1300 may employ a communication protocol and environment rules that may be used to exchange information 314a, 314b, weights 322a, 322b, object data 320a, 320b between node 302 and node 304. For example, environment rules can be based on network performance that dictates the frequency of ML model updates and/or weight updates. The communication protocol can be loss or lossless protocols and the number of retries, etc., per model is based on the model dynamics and the need for accuracy. On a low-performance network interface, the server device and the client device may negotiate a lower image resolution to prevent a high gap between the client and the server ML model updates.

The mutual learning process may include, at step 1308, providing, by the first computing node 302 and in near real time (or in real time), a first set of information 314a to dynamically update the set of machine learning models (e.g., ML models 302B). The first set of information 314a may include a phenotype that represents a selected NN evolved by the computing node 302. This phenotype may be integrated or used to build a new population (e.g., evolved out of NE techniques) that will be evolved on computing node 304, for example. In addition, the mutual learning process may include, at step 1310, providing, by the second computing node 304 and in near real time (or in real time), a second set of information 314b to dynamically update the set of machine learning models (e.g., ML models 302A). The second set of information 314b may include a phenotype that represents the selected NN evolved by the computing node 304. This phenotype will be integrated or used as is to build a new population that will be evolved on computing node 302.

In some embodiments, the mutual learning process may be supported by using one or more compression techniques when providing the first set of information 314a and providing the second set of information 314b, which may reduce the bandwidth requirements and accelerate the conversion process.

The compression techniques may be utilized by process 1300 to reduce computational effort on the first computing node 302 while reducing bandwidth usage (on the network) when communicating between the first computing node 302 and the second computing node 304. For example, using the ML described in FIG. 11a, the client and the server can use a few populations to compete on generating a desirable phenotype. The two nodes (or more) can interchange the generated desirable phenotype between them and continue to evolve a new population based on these new champions, until finding a solution. In this example, the entire system evolved may communicate without over taxing computer and/or network resources.

In some embodiments, the set of machine learning models (e.g., ML models 302B) is a superset of the set of machine learning models (302A). In some embodiments, the set of machine learning models (e.g., ML models 302B) may be executed by at least a portion of the set of machine learning models (ML models 302A). In some embodiments, the set of machine learning models (e.g., ML models 302A) may be executed by at least a portion of the set of machine learning models (ML models 302B).

In some embodiments, the first computing node 302 and the second computing node 304 may variably update the set of machine learning models 304B or the set of machine learning models 304A. The updates may occur independent of delays and packet drops associated with a network used to exchange the first set of information 312a and/or the second set of information 312b.

In some embodiments, the first computing node 302 is a server and the second computing node 304 is a client device. The node 302 may send a plurality of mainframes to the client device (e.g., node 304). In response, the client device may determine a plurality of intraframes associated with the plurality of mainframes and may render objects at the environment based on the plurality of mainframes and the plurality of intraframes.

In some embodiments, the process 1300 may further include sending, by the second computing node 304 and to the first computing node 302, a plurality of reverse mainframes and a plurality of reverse intraframes to update the plurality of reverse mainframes. The reverse mainframes and reverse intraframes may be sent according to a variable frequency and dynamic scale based on the environment and simulations operating in the environment.

In some embodiments, using the compression further includes mapping the plurality of mainframes and the plurality of intraframes with the plurality of reverse mainframes and the plurality of reverse intraframes to render objects in the environment, as described in detail in FIG. 10.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

FIG. 14 is an example system 1400 for learning and evolving content to be simulated and shared amongst client devices such as one or more user(s) 1402 (e.g., node 302, node 304, etc.).s A cloud or local server device 1404 may generate and/or render 31) scenes 1406 using one or more GPUs 1408. The server device 1404 may generate, maintain, and/or otherwise execute data associated with a mutualized pipeline 1410, a neural cache 1412, and/or views 1414.

Conventionally, presenting a high-quality simulation on the client device utilizes many processing resources, yet clients are resource-limited. One conventional solution utilizes the server device to perform such simulation processing (e.g., rendering, streaming, etc.) based on the server (or network) having more resources available than the client device. However, the server (or network) will still utilize resources for each client at a ratio of one resource portion to each client device. This shift of resource usage does not lower the cost of the resources utilized. However, the techniques described herein utilize ML models to execute training and/or generate preliminary content and/or perform preliminary rendering tasks at a server device 1404 and the server may provide short bursts of data (e.g., NVS data 1416) to each client device (e.g., User 1402) representative of such content or tasks while the client device 1402 is presenting data rendered by the ML model that is executing on the client device.

FIG. 15A is an example set of images 1502 that may be used to train the ML model (e.g., ML models 302a, 304a, etc. utilizing mutualized pipeline 1410, neural cache 1412, views 1414, etc.) and used by the client device 1402 (e.g., node 302, node 304, etc.). The set of images 1502 may represent image data for generating and/or rendering content for viewing at a client device.

FIG. 15B is an example of image data 1504 from one or more training sessions on the server device 1404, for example, combined with sparse data 1506, shown here as the partial image/outline of a character overlaid upon the image data 1504. The sparse data 1506 represents the NVS data 1416 of the short bursts of data that may be used for generating/rendering a full version of the sparse data 1506. For example, the sparse data 1506 may have been sent to the client device 1402 which presents this data or renders this data using the ML model 302a, 304a, etc.) trained on the server device 1404.

FIG. 15C depicts an example of a fully rendered result 1508 of using the sparse data 1506 and generating a fully rendered version of the character 1510 within the image data 1504. In this way, the server device 1404 can update the ML models described herein and continue and send additional sparse data to obtain an improved rendering simulation result (shown in FIG. 15C) and may support such rendering for many thousands of clients simultaneously in the same manner with little impact on client device 1402 and server device 1404 resources and without restrictions placed on the processing and/or speed differences between client devices.

The sparse data 1506 may be utilized as a way to allow a client device to add or modify a feature of a simulated environment and share such a modification or addition with any number of other peer devices (e.g., client devices). The ML models described herein may support peer to peer training such that a client device can add a feature into a peer shared simulated environment, update the training of the client device local rendering ML model, and share the update with any number of peers before sharing the sparse data (e.g., image data and/or image information and/or movement(s) captured. This now allows for all peers participate in this new updated simulation.

What is claimed is:

1. A system for facilitating a distributed learning and activation model for a machine learning program in an environment, the system comprising:
a plurality of computing nodes in networked communication, the plurality of computing nodes comprising a first set of computing nodes and a second set of computing nodes,
wherein the first set of computing nodes manages a first set of machine learning models and the second set of computing node manages a second set of machine learning models, and
wherein a first computing node in the first set of computing nodes and a second computing node in the second set of computing nodes cause mutual learning between two or more of the plurality of nodes by exchanging information in near real time to update the first set of machine learning models and the second set of machine learning models.

2. The system of claim 1, wherein the first set of machine learning models is a superset of the second set of machine learning models, and wherein the first set of machine learning models is configured to be executed by at least a portion of the second set of machine learning models.

3. The system of claim 1, wherein updating the first set of machine learning models and the second set of machine learning models occurs independent of delays and packet drops associated with a network used to exchange the information.

4. The system of claim 1, wherein the first computing node and the second computing node are configured to variably update the distributed learning and activation model.

5. The system of claim 1, further comprising:
one or more databases for storing information corresponding to the environment; and
object data associated with a plurality of objects, wherein the environment is a simulation environment.

6. The system of claim 5, wherein the first computing node is configured to determine a sequence of first frames of at least one object, in the plurality of objects, to be rendered at the environment, and wherein the second computing node is configured to determine a sequence of second frames for the at least one object, in the plurality of objects, to be rendered at the environment.

7. The system of claim 6, wherein at least one of the first computing node and the second computing node is configured to:
receive at least one of the first frames and the second frames;
correlate and map the first frames with the second frames to render the at least one object at the environment, wherein the machine learning model is configured to determine the at least one object to be rendered at the environment and wherein the environment is a simulation environment.

8. The system of claim 7, wherein the sequence of first frames are mainframes and the sequence of second frames are intraframes of the at least one object to be rendered at the environment.

9. The system of claim 7, wherein the sequence of first frames are intraframes and the sequence of second frames are mainframes of the at least one object to be rendered at the environment.

10. The system of claim 9, wherein the first computing node is a server and the second computing node is a client device, wherein the server is configured to send the mainframes to the client device and the client device is configured to be triggered to determine the intraframes and render the at least one object at the environment in response to receiving the mainframes from the server.

11. The system of claim 10, wherein the client device is configured to send reverse mainframes to the server and reverse intraframes to the server to update the reverse mainframes, wherein the client device is configured to be triggered to send, to the server, reverse mainframes and reverse intraframes on a variable frequency and dynamic scale based on the environment and simulation at the environment.

12. The system of claim 11, wherein the mainframes and intraframes are mapped with the reverse mainframes and reverse intraframes to render the at least one object in the environment.

13. The system of claim 1, wherein each of the plurality of computing nodes is configured to update weights of instances associated with the first set of machine learning models and instances associated with the second set of machine learning models.

14. The system of claim 5, wherein the first computing node and the second computing node are configured to negotiate which of the plurality of objects to select for rendering at the environment.

15. A method for facilitating a distributed learning and activation model for a machine learning program in an environment, the method comprising:
providing a plurality of computing nodes in networked communication, the plurality of computing nodes comprising a first set of computing nodes and a second set of computing nodes;
managing a first set of machine learning models by a first computing node in the first set of computing nodes and managing a second set of machine learning models by a second computing node in the second set of computing nodes;
enabling a mutual learning process between the first computing node and the second computing node by:
providing, by the first computing node and in near real time, a first set of information to dynamically update the first set of machine learning models, and
providing, by the second computing node and in near real time, a second set of information to dynamically update the second set of machine learning models;
wherein the mutual learning process is performed using compression when providing the first set of information and providing the second set of information, wherein the compression is a reversible compression between the first computing node and the second computing node and configured to reduce computational effort on the first computing node while reducing bandwidth usage when communicating between the first computing node and the second computing node.

16. The method of claim 15, wherein the first set of machine learning models is a superset of the second set of machine learning models, and wherein the first set of machine learning models is configured to be executed by at least a portion of the second set of machine learning models.

17. The method of claim 15, wherein the first computing node and the second computing node variably update the first set of machine learning models or the second set of machine learning models, and the updates to the first set of machine learning models and the second set of machine learning models occur independent of delays and packet drops associated with a network used to exchange the first set of information and the second set of information.

18. The method of claim 15, wherein the first computing node is a server and the second computing node is a client device, the server being configured to send a plurality of mainframes to the client device and the client device is configured to determine a plurality of intraframes associated with the plurality of mainframes and render objects at the environment based on the plurality of mainframes and the plurality of intraframes.

19. The method of claim 15, further comprising: sending, by the second computing node and to the first computing node, a plurality of reverse mainframes and a plurality of reverse intraframes to update the plurality of reverse mainframes at a variable frequency and dynamic scale based on the environment and simulations operating in the environment.

20. The method of claim 19, wherein using the compression further comprises:
mapping the plurality of mainframes and the plurality of intraframes with the plurality of reverse mainframes and the plurality of reverse intraframes to render objects in the environment.
